(19) United States
(12) Patent Application Publication
(10) Pub. No.: US 2004/0130675 A1
(43) Pub. Date: Jul. 8, 2004

(54) Attachment device for eyeglasses

(76) Inventor: Einar Einarsson, Reykjavik (IS)

Correspondence Address: Steven S. Payne, Law Office of Steven S. Payne, 8027 ILIFF Drive, Dunn Loring, VA, 22027, US

(21) Appl. No.: 10/337,395

(22) Filed: Jan. 7, 2003

(51) Int. Cl. G02C 5/04

(52) U.S. Cl. 351/128

(57) ABSTRACT

An attachment device for arranging a pair of supplementary lenses onto an eyeglass frame is disclosed. Such supplementary lenses, such as sunshades, are removably arranged onto tradition eyeglass frames. The supplementary lenses are arranged on the eyeglass frame in such a manner that none, or at least very limited amendments or adjustments are required with respect to the particular eyeglasses.

### FIELD OF THE INVENTION

The invention relates to attachment device for arranging a pair of supplementary lenses onto an eyeglass frame. Such supplementary lenses being for example sunshades removably arranged onto any kind of traditional eyeglass frames. The invention is primarily concerned with providing removable sun protection for attachment to any eyeglass frame.

### BACKGROUND OF THE INVENTION

The glaring rays of incoming sunlight are often extremely distracting and may be painful to some people. To reduce or block out as much of this distracting sunlight as possible, individuals generally resort to sunglasses with colored or tinted protective lenses, or attachments for eyeglasses which have the same protective colored or tinted lenses. However, sunglasses or traditional eyeglass attachments with protective lenses are often expensive and may require specific adjustments/amendments of the individual eyeglass frame structure,

The prior art is replete with references disclosing sunglasses and devices for attachment to eyeglasses for protecting the distracting rays of the sun from reaching one's eyes.

U.S. Pat. No. 5,056,906 discloses a prescription lens attachment for sunglasses. The invention allows sunglasses to be retrofitted to accept lenses that are smaller than the lenses of the sunglasses. Appropriately shaped wires are secured to the frame and the lenses are then held by the wires.

U.S. Pat. No. 3,427,098, U.S. Pat. No. 3,890,037 and U.S. Pat. No. 4,338,004 each disclose sunshades that can be removably attached to a pair of ordinary glasses on the side of the lens adjacent to the face for a user.

The invention proposed differs form the above '906 patent, primarily in that the structure rests on the nose pad structure of the eyeglasses, wherein the '906 patent describes wire structure to fit prescription lenses to sun-glass frame. The wire structure is individually fitted to the particular frame/lenses.

In addition the '098, '037 and '004 patents disclose lenses that must be used in conjunction with glasses that are specially prepared to receive the lenses.

Additionally none of the lenses in the referred patens are attached to the nose pad structure of the eyeglasses. Instead, the lenses in all of the patents are fitted onto the frame of the eyeglasses and far from being easily removable.

Accordingly, there is clearly a need for an easily fitted and removable attachment device providing sun glass protection onto any kind of eyeglass frame which is lightweight, inexpensive, attractive and stylish.

### SUMMARY OF THE INVENTION

It is the general objective of the present invention to provide an attachment device for arranging a pair of supplementary lenses onto an eyeglass frame in such a manner that none, or at least very limited amendments or adjustments are required with respect to the particular eyeglasses.

This objective is achieved by providing an attachment device that is unique in the way that it comprises an opposite arranged fastening means for connecting said pair of lenses thereto,

an adjustable bridge member attaced in-between said opposite arranged fastening means, and

an engagement member for interacting with the mid section structure of said eyeglass frame,

wherein said adjustable bridge member supports said engagement members for allowing displacement of said engagement members with respect to said mid section structure of said eyglass frame during connection and disconnection of the device.

The invention is further unique according to the embodiment set forth in claims 2-14.

### DESCRIPTION OF THE DRAWINGS

The invention will hereinafter be described in further details with reference to the accompanying drawings, wherein;

FIG. 1 shows the attachment device with pair of supplementary lenses,

FIG. 2 shows the attachment device being arranged onto aneyeglass frame,

FIG. 2a shows in further details attachment of the device to the nose pad structure of the eyeglass frame,

FIGS. 3-6 show different configuration of the lens holder/attachment device,

FIGS. 7 and 7a show length adjustments to the lens holder/attachment device,

FIGS. 8-10 show varying configuration of the attachment/coupling devices,

FIGS. 11-16a show varying fastening of the lenses to the lens holder,

FIGS. 17-18 show one embodiment particular variation of the attachment device, and its arrangement onto eyeglass frame,

FIGS. 19-20 show different view of FIG. 17-18,

FIGS. 21-24 show yet another embodiment of the lens holder/attachment device,

FIGS. 25-27 show further one embodiment of an adjustable length of the engagement member,

FIG. 28-31 show two modifications of the device and its arrangement onto an eyeglass frame,

FIG. 32-39 show a selection of lens design,

FIGS. 40-43 show in further detail variation of the engagement member and the attachment of the lenses thereto and its arrangement onto eyeglass frame.

### DETAILED DESCRIPTION OF THE PRESENTLY PREFERRED EMBODIMENT

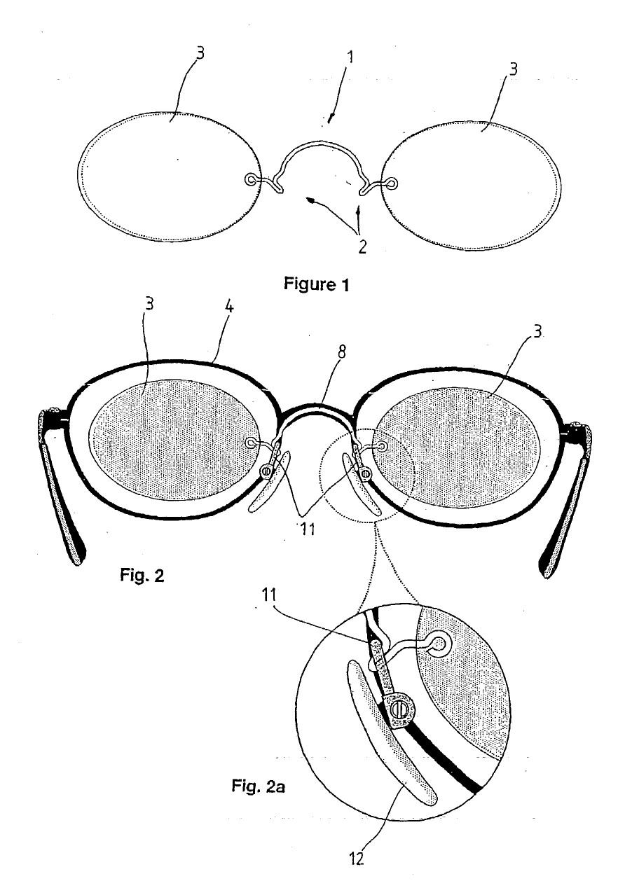

As seen on FIG. 1, 2 and 2a one particular embodiment of the attachment device is exemplified. A pair of supplementary lenses (3) are connected together by a lens holder (1). The lens holder (1) comprises a pair of opposite arranged engagement members (2) for interaction (coupling) with the mid structure (6) of the spectacle frame (4). The lens holder (1) further comprise fastening means (9) for attaching the lenses (3) thereto. In between the engagement members (2) a bridge structure (8) is arranged. The bridge structure (8) is at least partly elastic and/or arc formed and made of such elastic character material allowing at feast partial displacement of the engagement members (2) for bringing those in and out of connection, for example with the nose pad structure (25), in particular the nose pad arms (11) of the eyeglass frame (4).

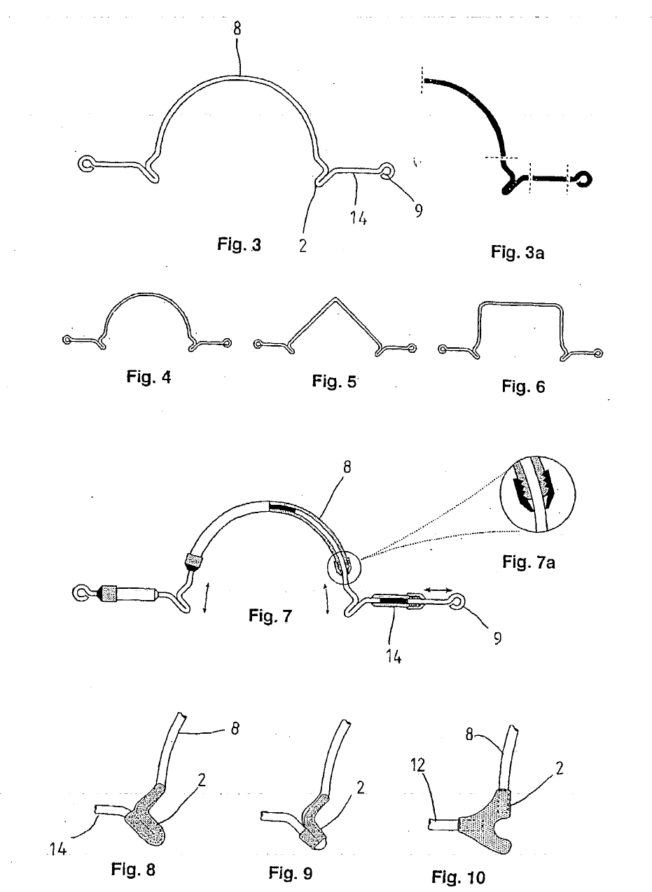

FIG. 3-6 show different configuration of the lens holder/attachment device (2). The holder is preferably made of stiff spring material forming an arc or similar structure in between the engagement members (2). On opposite ends fastening means (9) is arranged for forming connection to the lenses (not shown). As shown the bridge structure (8) is of varying configuration in which can have both functional and/or esthetic purpose.

FIG. 7 and 7a show length adjustments of the lens holder (1) wherein the length of the bridge structure (8) in between the engagement members (2) as well as the leg section (14) in between the engagement members (2) and the end fastening means (9) can be adjusted.

FIG. 8-10 show different configuration of the engagement member (2a, 2b, 2c). The lens holder structure (1) is as shown on FIG. 8 and 9 formed of bendable wire construction and the engagement members covered with material such as rubber or plastic for allowing smother connection for example the nose pad arms (11) of the eyeglass frame (4). In FIG. 10 a specifically manufactured engagement member with assembly for the bridge structure (8) and the leg structure (14) is introduced. By providing such a configuration bendings are minimized.

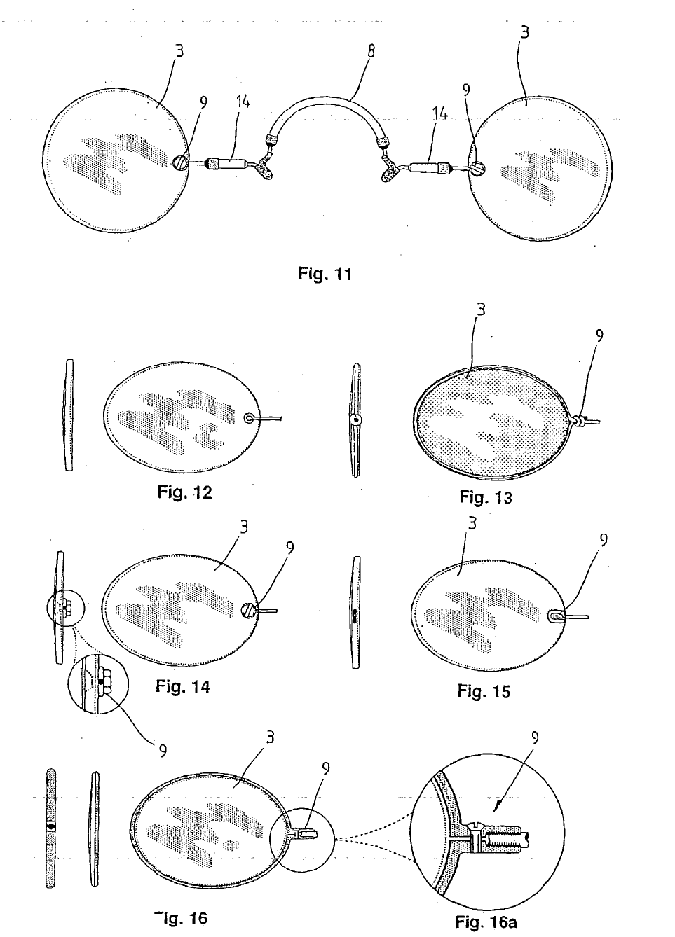

FIG. 11 shows fully adjustable attachment device (1) with lenses (3) attached thereto. The bridge structure (8) and leg structure (14) are both length adjustable.

FIG. 12-16a show different arrangement of fastening means (9) for fastening the lenses (3) to the lens holder.

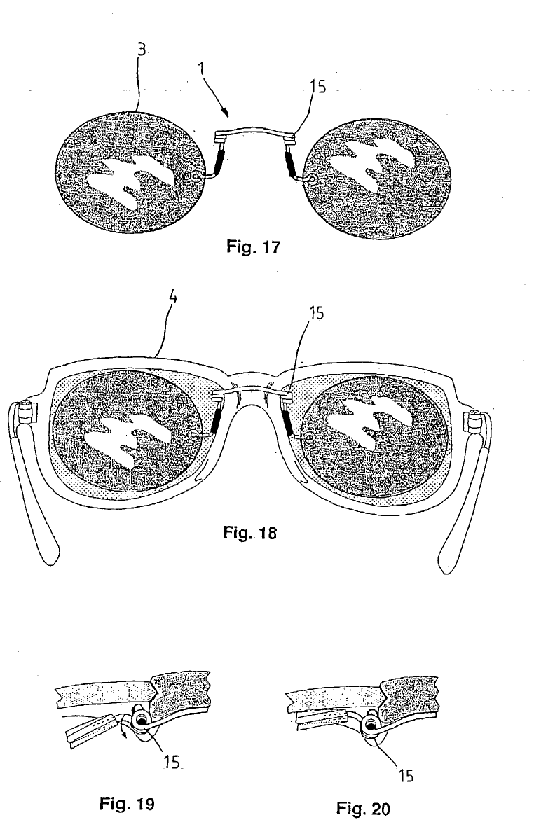

FIG. 17-20 show a further embodiment of the lens holder (1) wherein a pair of spiral formed springs (15) are arranged to allow adjustments of the position of the engagement members (25), herein formed as pads (22) resting on the outer side of the nose pad structure of the mid section of the eyeglass frame (4).

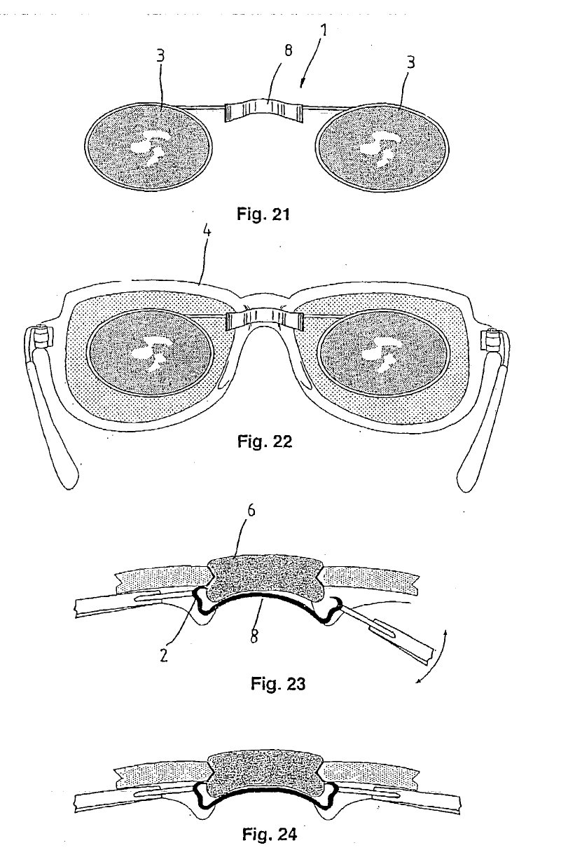

FIG. 21-24 show yet another embodiment of the lens holder (1) and the engagement members. Here yet another embodiment of the engagement member (21) is introduced, where-it is locked to the bridge structure (8) of the eyeglass frame (4).

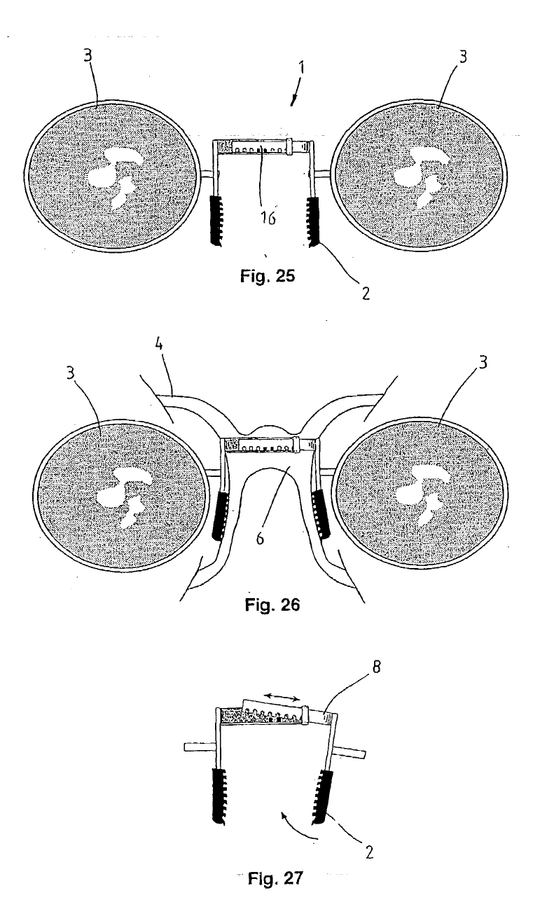

FIG. 25-27 show further additional embodiments of the lens holder (1) and engagement member (24) where the distance between the engagement members (24) is adjustable by a pall mechanism (16) an the bridge structure (8).

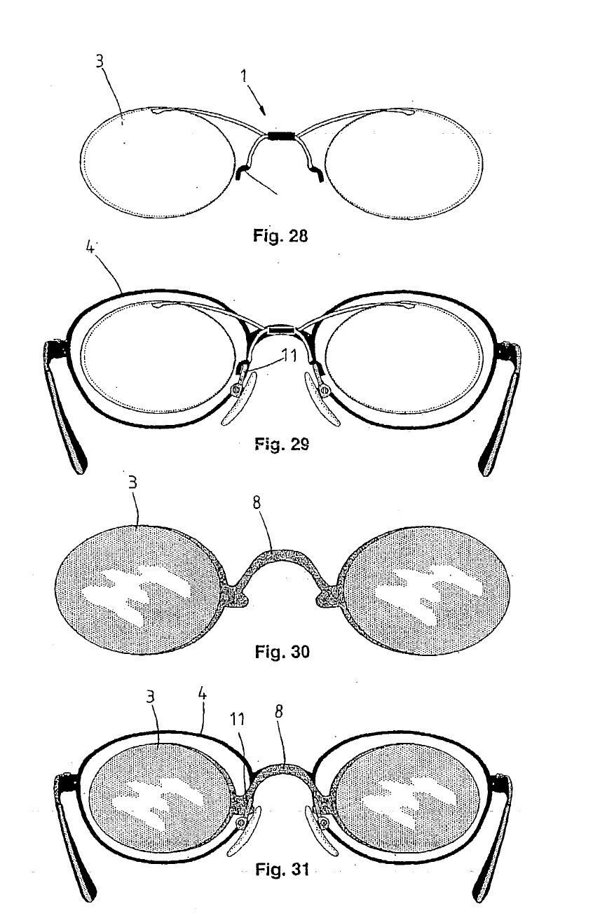

FIG. 28-31 show two additional embodiments of the lens holder (1) and the engagement member (23). The engagement member (23) (FIG. 28 and 29) rest on the nose pad structure (25), but is not fastened thereto.

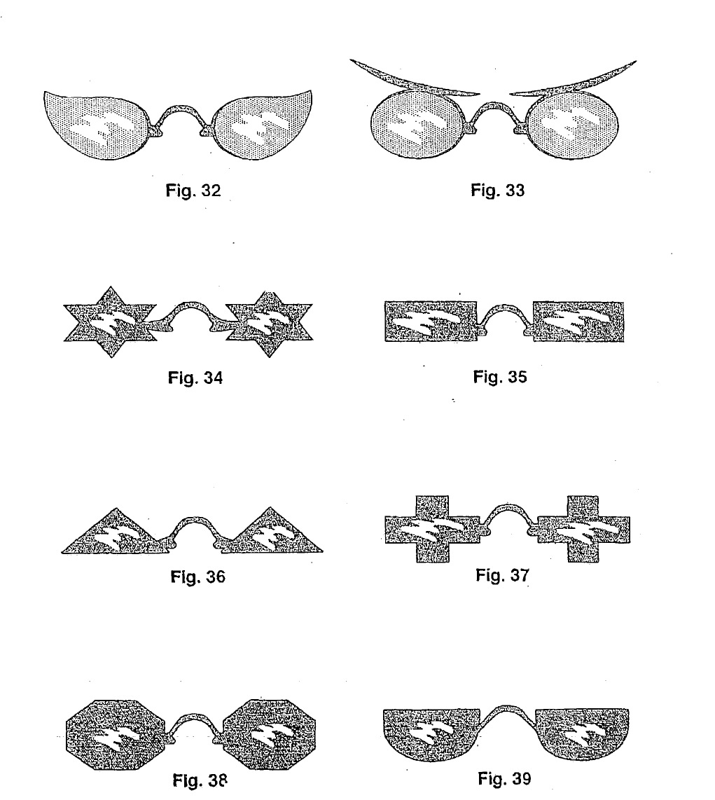

FIG. 32-39 show a small selection of possible designs of the lenses, such as sunglass lenses to be arranged to give the person wearing them a particular appearance.

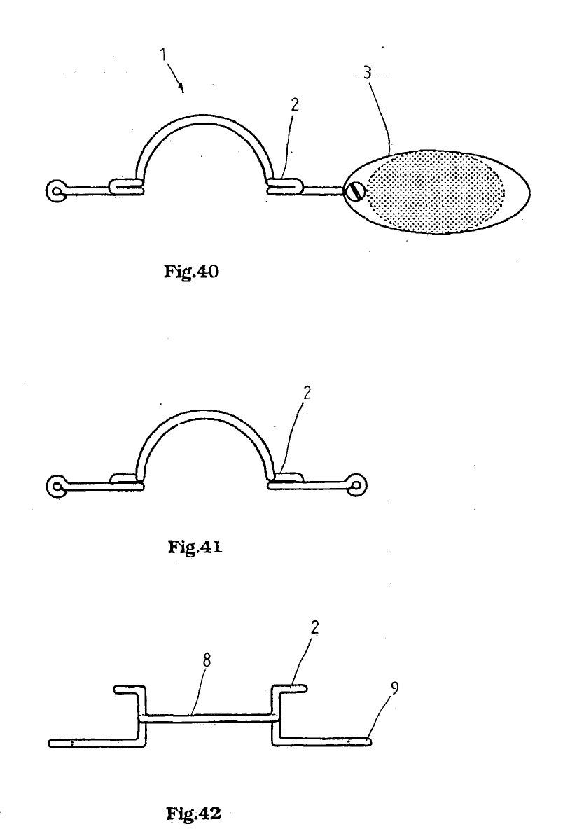

FIG. 40-43 show further one embodiment of the engagement member (2) where the wire or frame forming the lens holder is bent forward and to the inside instead of down as shown in many of the previous figures.

It should be understood that although the lenses referred to on the figures as number 3, are shown mainly as additional lenses such as sunglass lenses, the opposite is of course quite easily achievable, e.g. by arranging a pair of prescription lenses or special purpose lenses onto sunglasses or for that matter any possible combination.

The above description sets forth rather broadly the most important feature of the present invention. It is to be understood, however, that the drawings are produced solely for the purpose of illustration and not set forth to define the limits of the invention, The invention described here above is not limited to precisely those details which have been specified, but can be elaborated upon in many ways without deviating from the central concept and spirit of the invention as defined in the patent claims below.

1. Attachment device for arranging a pair of supplementary lenses onto an eyeglass frame (4) by a lens holder (1) for connecting said pair of lenses (3) onto said eyeglass frame (4), said lens holder comprising;
an opposite arranged fastening means (9) for connecting said pair of lenses (3) thereto,
an adjustable bridge member (8) attaced in between said opposite arranged fastening means (9), and
an engagement member (2) for interacting with the mid section structure (6) of said eyeglass frame (4),
wherein said adjustable bridge member (8) supports said engagement members (2) for allowing displacement of said engagement members with respect to said mid section structure (6) of said eyglass frame (4) during connection and disconnection of the device.

2. Attachment device according to claim 1, further comprising a leg section (14) in between the engagement members (2) and the fastening means (9).

3. Attachment device according to claim 1 or 2, wherein the engagement member (2) are opposite arranged.

4. Attachment device according to claim 1, 2 or 3, wherein the engagement members (2) are arranged symetrically towards each other.

5. Attachment device according to any of the preceding claims, wherein said engagement member (2) further comprises a pair of coupling means (2, 2a,-2c, 21, 22, 23, 24) for interacting with said mid section structure (6), in particular the nose pad structure (25) on said eyeglass frame (4).

6. Attachment device according to any of the preceding claims, wherein said coupling means (2) further includes hooking configurations (21) interacting with the mid section structure (6) of the eyeglass frame (4)

7. Attachment device according to any of the preceding claims, wherein said adjustable bridge member being flexible and allowing displacement of said engagement means (2) with respect to said mid section structure (6) of said eyeglass frame (4).

8. Attachment device according to any one of the preceding claims, wherein said adjustable bridge member includes length adjustment means (18) allowing displacement of said engagement means (2) with respect to said mid section structure (8) of said eyeglass frame (4).

9. Attachment device according to any one of the preceding claims, wherein said lens holder (1) further includes length adjustment means (14) allowing displacement of said pair of lenses (3), with respect to said eyeglass frame (4).

10. Attachment device according any one of the preceding claims, wherein said pair of lenses (3) are sunshades.

11. Attachment device according to any one of the preceding claims, wherein said pair of lenses (3) are circular, semicircular, triangular, quadrangular, polygonal, star-formed, or of any such form adding a characteristic appearance to the eyeglasses.

12. Use of the attachment device as any in of the preceding claims, to attach a pair of supplementary lenses onto an eyeglass frame.

13. Attachment device for attaching a pair of supplementary lenses onto an eyeglass frame as herein before described with reference to FIGS. 1-43.

14. Use of the device claimed in any of the claims 1-13.
